(19) United States
(12) Patent Application Publication
(10) Pub. No.: US 2008/0032081 A1
(43) Pub. Date: Feb. 7, 2008

(54) Grip tab for labels

(75) Inventor: Timothy L. Gelsinger, Long Valley, NJ (US)

Correspondence Address: GREER, BURNS & CRAIN, 300 S WACKER DR, 25TH FLOOR, CHICAGO, IL, 60606, US

(73) Assignee: Challenge Printing

(21) Appl. No.: 11/498,395

(22) Filed: Aug. 3, 2006

(51) Int. Cl. B32B 37/12; B32B 38/04; B32B 38/14; B32B 37/26; B32B 33/00

(52) U.S. Cl. 428/40.1; 156/152; 156/270; 156/268; 156/267; 156/277

(57) ABSTRACT

A label product has a base label and a printed piece secured over the base label by a laminate. A corner or other portion of the base label is die-cut to form a grip tab, and the pressure sensitive adhesive beneath the grip tab is deadened. When a release liner is removed and the base label is adhered to a product, the laminate can be removed to expose the printed piece by lifting the grip tab.

This invention relates to pressure sensitive adhesive labels, and more particularly, to booklets laminated on pressure sensitive adhesive base labels, with grip tabs made by cutting the base labels.

### BACKGROUND OF THE INVENTION

A booklet can be secured to a pressure sensitive adhesive base label by laminating the booklet over the base label. However, lifting the laminate to open and obtain access to the booklet is difficult, because the laminate is adhered to the base label by pressure sensitive adhesive. Thus, there is a need for such label products that are easier to open.

Accordingly, one object of this invention is to provide new and improved label products having booklets or other printed pieces laminated on pressure sensitive adhesive base labels.

Another object is to provide such label products with grip tabs.

Still another object is to provide such label products with grip tabs made by cutting the base labels and deadening the adhesive beneath the grip tab.

### SUMMARY OF THE INVENTION

In keeping with one aspect of the invention, a label product has a base label and a printed piece secured over the base label by a laminate. A corner or other portion of the base label is die-cut to form a grip tab, and the pressure sensitive adhesive beneath the grip tab is deadened. When the release liner is removed and the base label is adhered to a product, the laminate can be removed to expose the printed piece by lifting the grip tab.

### BRIEF DESCRIPTION OF THE DRAWINGS

The above mentioned and other features of this invention and the manner of obtaining them will become more apparent, and the invention itself will be best understood by reference to the following description of an embodiment of the invention taken in conjunction with the accompanying drawings, in which:

FIG. 1 is a plan view of a succession of label products on a web of release material;

FIG. 2 is a side view of a label product of FIG. 1, taken along lines 2-2 in FIG. 1; and

FIG. 3 is a block diagram illustrating the manufacturing process used to produce the label products of FIGS. 1 and 2.

### DETAILED DESCRIPTION

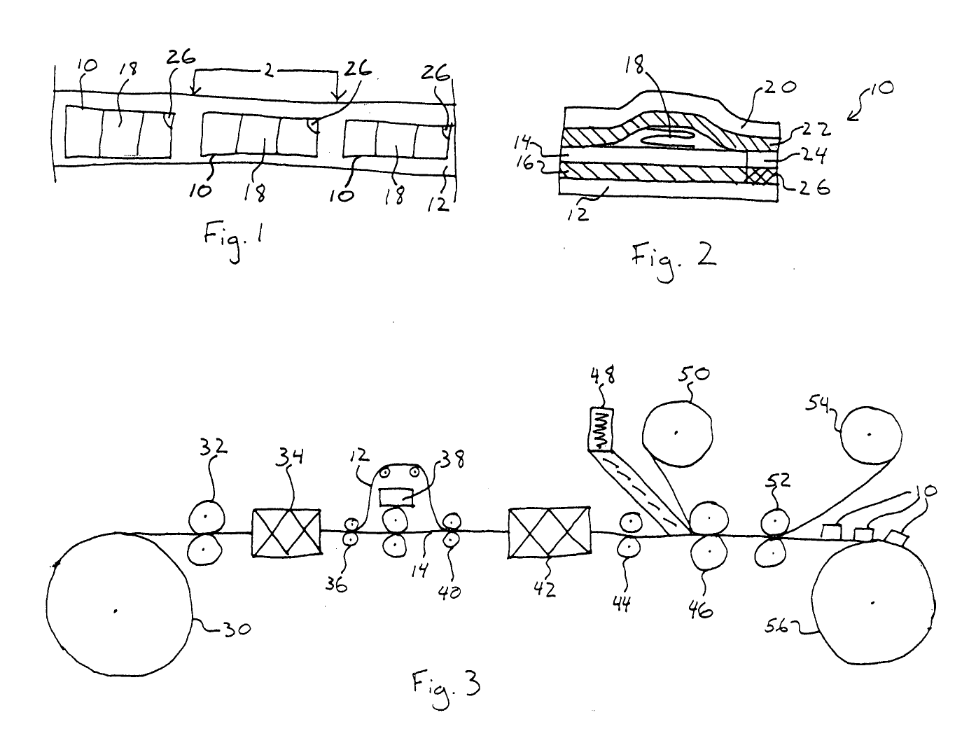

As seen in FIGS. 1 and 2, a succession of spaced label products 10 are located at predetermined positions along a release liner 12. The label products 10 include a piece of base label paper 14 having a layer of pressure sensitive adhesive 16 on a first surface thereof. The release liner 12 is located beneath the pressure sensitive adhesive layer 16.

The surface opposite the layer of pressure sensitive adhesive 16 is at least partially covered with a printed piece 18 such as a booklet or the like, and a laminate material 20 covers substantially all or all of the base label paper 14. The laminate material 20 is secured over the printed piece 18 and the exposed portions of the base label paper 14 by a layer of pressure sensitive adhesive 22. The printed piece 18 can be separately adhered to the base label paper 14, if desired, but it is not necessary.

The label product 10 also has a grip tab 24 in a corner portion 26 or other portion of an edge of the label product 10. The grip tab 24 is cut from the label paper 14. The adhesive layer 16 beneath the grip tab 24 is deadened in any of several known ways, such as printing a commercially available adhesive deadener on the adhesive in the portion 26.

The label product 10 can be applied to an object such as a bottle, box or other container or the like by removing the release liner 12 and applying the pressure sensitive adhesive 16 to the object. The deadened adhesive 26 does not adhere to the object, however, so the grip tab 24 can be easily lifted and pulled to remove enough laminate 20 to expose the printed piece 18. If the printed piece 18 is a booklet, the booklet can be opened and read.

A succession of label products 10 can be produced in reel form in the manner shown in FIG. 3. A web of base label paper 14 having pressure sensitive adhesive on one surface thereof, covered by the release liner 12, can be purchased commercially in the form of a reel of label stock 30. The surface of the base label paper opposite the layer of adhesive can be unprinted, pre-printed or printed at a print station 32.

In one embodiment, the web of printed label stock material is inverted in a known manner at an inversion station 34. The release liner 12 of the inverted web is separated from the base label paper at a separation station 36, and the base label paper is fed through an adhesive deadener station 38. The adhesive deadener station 38 can take many forms, but is preferably a print station which prints the adhesive deadener portions 26 at selected locations along the base label paper. The selected portions will become grip tabs 24 for removing the laminate after adhesion of the label products on products.

As the base label paper is treated with the adhesive deadener, the release liner bypasses the adhesive deadener station 38, and is reunited with the base label paper 14 at a pair of nip rollers 40 or other location along the path of travel. The web is then inverted at a second inversion station 42.

The portions of the base label paper 14 which have deadened adhesive are die cut to form the grip tabs 24 at a die cutting station 44, without cutting through the release material or removing anything. After die cutting, the web travels to a printed piece and/or lamination applying station 46. The printed pieces are fed to the station 46 by a piece feeder 48, and a web of laminate material is provided from a reel 50. The printed piece placement is performed so that the printed pieces 18 are located in spaced relation to the selected adhesive deadened portions 24.

The label products 10 are die cut from the web at a second die cutting station 52. The laminate 20 and base label paper 14 are die-cut, usually without cutting the release liner 12. The printed pieces 18 can be flush cut along the side edges of the paper 14 if appropriate. A waste matrix of laminate and base label paper outside of the label products is produced at the die cutting station 52 and removed. The waste matrix can be wound on a reel 54, while a web of spaced label products 10 is wound onto a rewind reel 56. Of course, the label products 10 could be cut into individual labels, if desired.

While the principles of the invention have been described above in connection with specific apparatus and applications, it is to be understood that this description is made only by way of example and not as a limitation on the scope of the invention.

What is claimed is:

1. A method for making label products comprising the steps of:
moving a web of label stock along a path, the label stock having a web of base label paper having pressure sensitive adhesive a first surface thereof, and a release liner on the first surface;
inverting the web;
removing the release liner from the surface of the base label paper;
printing a deadener on selected portions of the first surface of the base label paper, to deaden the pressure sensitive adhesive at those portions;
replacing the release liner on the first surface of the base label paper;
reinverting the web;
die cutting the selected portions of the base label paper from the remaining base label paper without removing the selected portions;
placing a succession of printed pieces at predetermined spaced locations along the web, each spaced location being in spaced relation to one of the selected portions;
adhering a pressure sensitive adhesive laminate over the printed pieces and base label paper;
die cutting the base label paper without die cutting the release liner, to produce a succession of the spaced label products along the web, each label product having one of the printed pieces and one of the selected portions at an edge of the label product; and
removing base label paper and laminate which is outside of the label products,
whereby the label products can be applied to objects when the release liner is removed, and the laminate can be removed to expose the printed pieces by lifting the selected portions of the label products.

2. The method of claim 1 comprising:
printing information on a second surface of the base label paper.

3. The method of claim 1 wherein the selected portions are in a corner of the label products.

4. A label product comprising:
a piece of base label paper having two surfaces, a first surface having a layer of pressure sensitive adhesive thereon, a selected portion of the pressure sensitive adhesive at an edge of the base label paper being deadened;
a layer of release material on the first surface of the paper;
a printed piece located on a second surface of the base label paper; and
pressure sensitive laminate material covering the printed piece base label paper including the selected portion,
the base label paper being cut over the selected portion at which the adhesive has been deadened so that the label product can be applied to an object when release liner is removed, and the laminate can be removed to expose the printed piece by lifting the selected portion of the label product.
